(19) United States
(12) Patent Application Publication
(10) Pub. No.: US 2020/0107635 A1
(43) Pub. Date: Apr. 9, 2020

(54) ADJUSTMENT MECHANISM FOR OVER-DOOR HANGING SYSTEM AND METHOD OF USE

(71) Applicant: April M. Mitchell, Oceanside, CA (US)

(72) Inventor: April M. Mitchell, Oceanside, CA (US)

(21) Appl. No.: 16/705,809

(22) Filed: Dec. 6, 2019

Related U.S. Application Data
(63) Continuation-in-part of application No. 15/986,330, filed on May 22, 2018, now Pat. No. 10,512,325.
(60) Provisional application No. 62/509,854, filed on May 23, 2017.
(60) Provisional application No. 62/625,498, filed on Feb. 2, 2018.

(51) Int. Cl. A47B 57/14; A47G 25/06; F16B 7/10

(52) U.S. Cl. CPC A47B 57/14; F16B 7/105; A47G 25/0614

(57) ABSTRACT

A storage management system having a crossbar and pair of vertical arms which are hung by flat hooks over a door. A pair of slides can slide up and down the vertical arms and are secured using an adjustment mechanism. These slides can provide storage solutions to a side of a door, freeing up other space for additional uses. Such storage solutions may include hooks, baskets, bags, or other storage elements. The adjustment mechanism may include a spring for being pulled out and automatically springing back into a number of adjustment slots along the slides. Alternatively, the adjustment mechanism could simply be screwed into the desired slot, locking the slide in place.

### CROSS-REFERENCE TO RELATED APPLICATION

This application is a continuation-in-part of and claims priority in U.S. patent application Ser. No. 15/986,330 Filed May 22, 2018, which claims priority in U.S. Provisional Patent Application No. 62/509,854 Filed May 23, 2017, and in U.S. Provisional Patent Application No. 62/625,498 Filed Feb. 2, 2018, all of which are incorporated herein by reference.

### BACKGROUND OF THE INVENTION

### 1. Field of the Invention

The present invention relates generally to an item hanging system and method for use thereof, and more specifically to an adjustment mechanism and its use with an over-door mounted hanging system with adjustable hooks.

### 2. Description of the Related Art

Storage solutions are a widely sought after commodity, especially in rooms or homes with limited storage space. Some storage solutions are necessary for specific items, while others simply open up areas for storage which previously provided no storage at all.

Heretofore there has not been available a system or method for an over-door hanging system with the advantages and features of the present invention.

### BRIEF SUMMARY OF THE INVENTION

The present invention generally provides an over-door hanging system with a pair of adjustable hanging hooks. A cross bar with a pair of squared hooks engages with the top of a door, the hooks being thin enough to allow the door to be shut while the hooks are engaged with the top of the door.

A pair of vertical arms extend down from either end of the cross bar. Each arm has a plurality of mounting holes for receiving a mounting pin which is connected to the pair of adjustable hanging hooks. Each of the adjustable hanging hooks has at least one hook element, but preferably has two or more.

Each hanging hook can be adjusted vertically separate from the other hanging hook. The mounting pin can be spring-mounted to the adjustable hanging hooks or may screw into and out of the hanging hooks, thereby engaging with one of the mounting holes of the vertical arms.

An alternative embodiment employs the adjustable sliders along a bracket for other organizational purposes, such as for hooks, organizers, baskets, storage containers, adjustable shelves, or any other suitable purpose. The grippable handle can be pulled out or unscrewed from a slot within a bracket, allowing a slider to slide along the bracket, where the handle can then be inserted into another slot, locking the slider into place along the bracket.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention.

FIG. 2 is a side elevational view thereof.

FIG. 3 is a rear elevational view thereof.

FIG. 4 is a front elevational view thereof.

FIG. 5 is a top plan view thereof.

FIG. 6 is a bottom plan view thereof.

FIG. 7 is a three-dimensional isometric view of an alternative embodiment of the present invention about a top-left edge.

FIG. 8 is a three-dimensional isometric view thereof about a top-right edge.

FIG. 9 is a front elevational view thereof.

FIG. 10 is a detailed view taken about the circle of FIG. 9.

FIG. 11 is a side elevational view showing details of the present invention.

FIG. 12 is a front elevational view showing details of the present invention.

FIG. 13 is a three-dimensional isometric view of an alternative embodiment of the present invention.

FIG. 14 is a three-dimensional isometric view thereof shown in a slightly altered orientation.

FIG. 15 is a three-dimensional isometric view thereof shown in a slightly altered orientation.

FIG. 16 is a three-dimensional isometric view thereof shown in a slightly altered orientation.

FIG. 17 is a detailed view of elements of the embodiment of FIGS. 13-16.

FIG. 18 is another detailed view thereof.

FIG. 19 is yet another detailed view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Over-Door Hanging System 2

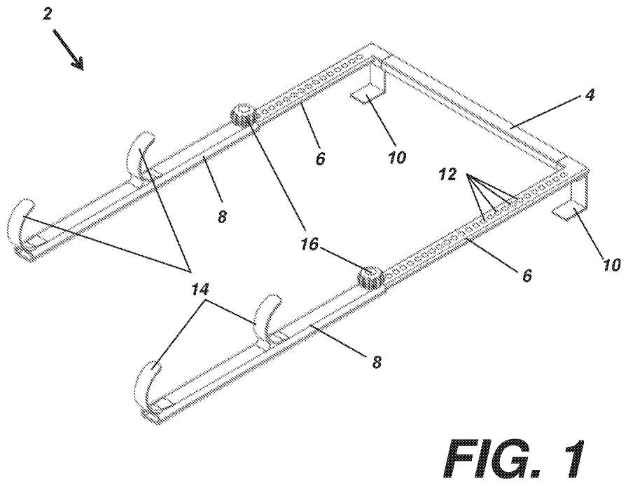

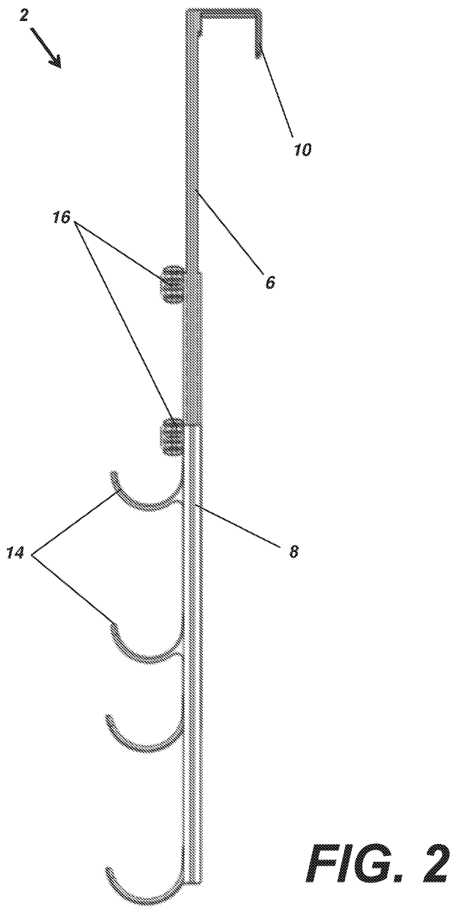

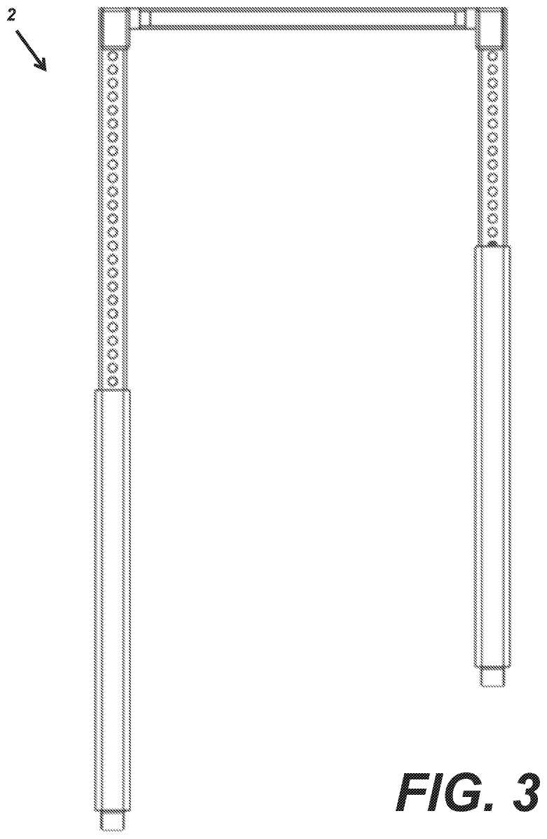

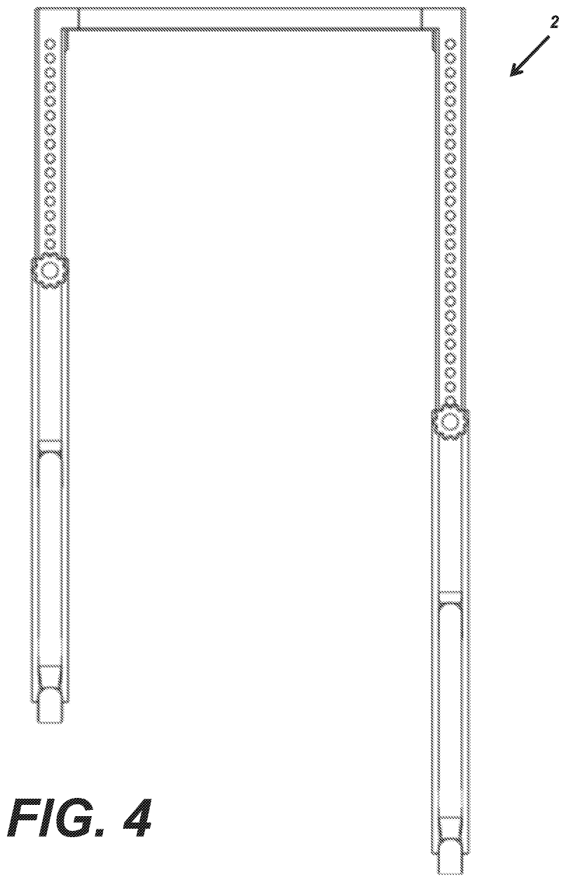

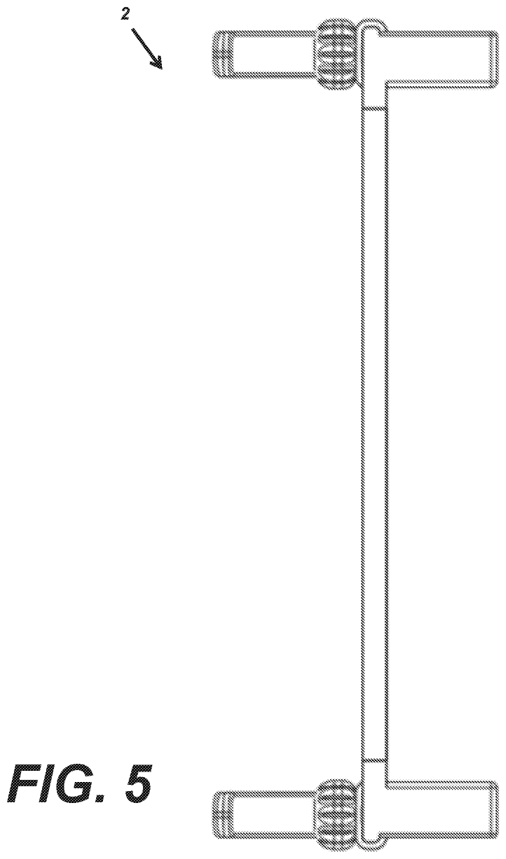

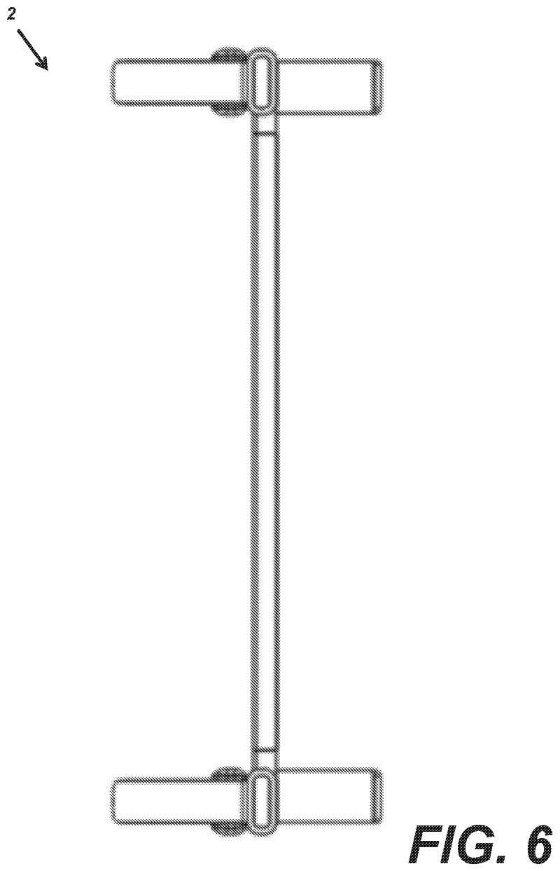

As shown in FIGS. 1-6, the present invention is an over-door hanging system 2. It includes a horizontal crossbar member 4 with two flat hooks 10 for hooking over and engaging the top edge of a door. The flat hooks 10 should be thin enough to allow the door to close while the flat hooks remain engaged with the door.

A pair of vertical arms 6 extend down from the horizontal crossbar. These arms include several mounting holes 12 for receiving mounting pins 16 which connect a pair of slides 8, each having hooks 14, onto the arms 6. Each arm includes at least one sliding hook, and could contain more. The hooks could be separate or connected as shown in the figures. The mounting pin 16 could be unscrewed to disengage and screwed back in to reengage with the mounting holes, or could be connected with a spring connection or other mounting means.

The length of the vertical arms could be of any suitable length to allow the hooks to be adjusted vertically. There could be any number of hooks. The figures show a hook element on each vertical arm, each having two hooks. However, each could have one or more hooks as desired.

### III. Alternative Embodiment Adjustment Mechanism System 102

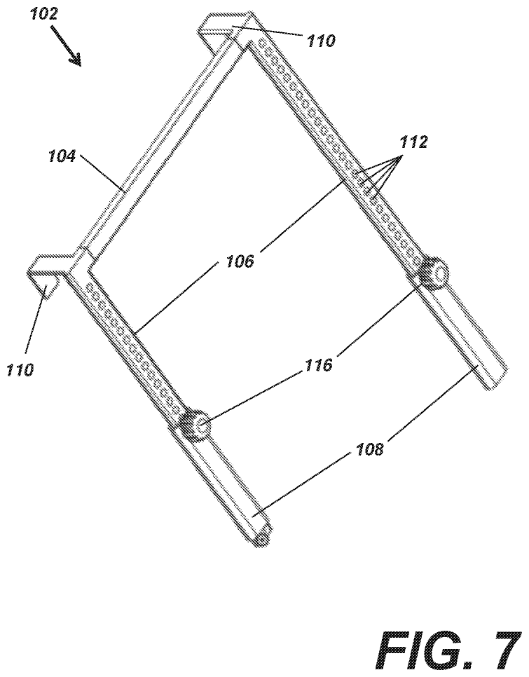

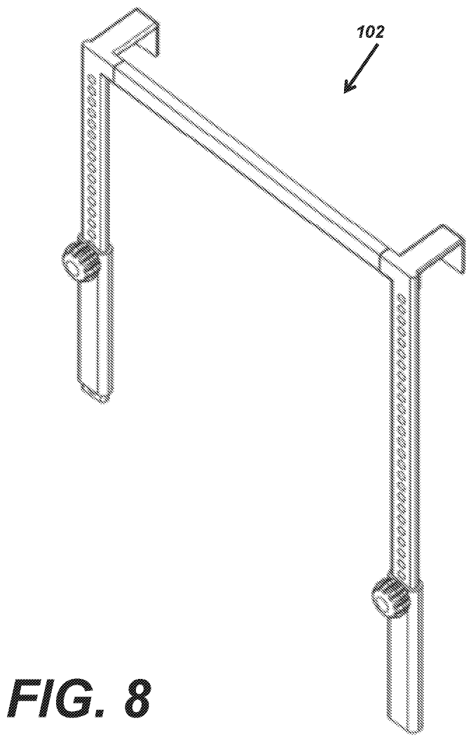

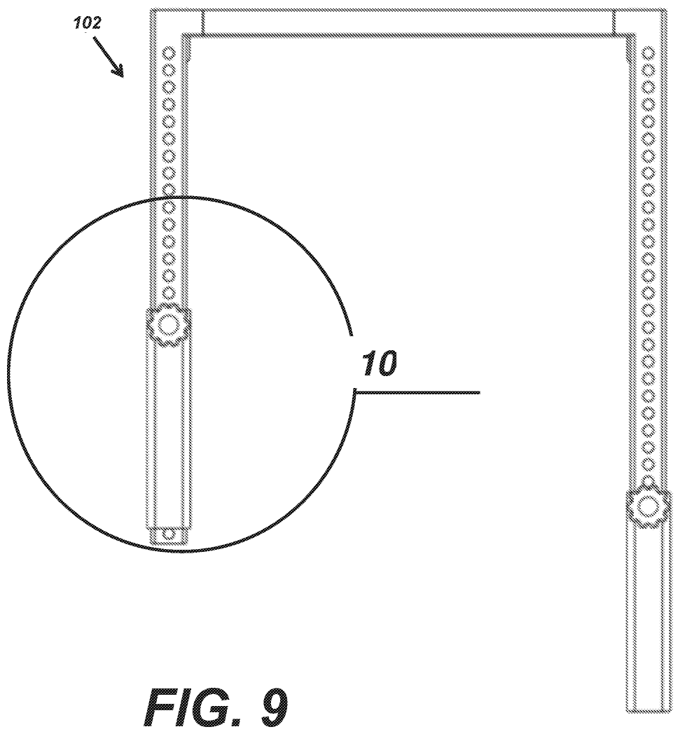

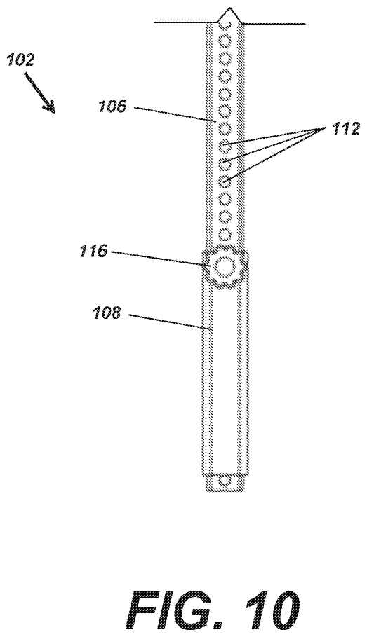

FIGS. 7-10 show an alternative embodiment adjustment mechanism system 102 which does not rely on the hooks of the previous embodiment. The adjustment device used with the first embodiment over-door hanging system above could be used for many other applications, especially for house organization and storage applications. The adjustment element includes a grippable handle 116 which can be pulled or unscrewed to be removed from a first slot, allowing a slider 108 to be raised or lowered along a bracket, and then the handle can be screwed or inserted into a second one of the slots 112 to lock the slider into place. This could be used to hold hooks, organizers, baskets, storage containers, adjustable shelves, or any other suitable purpose.

The embodiment adjustment mechanism system 102 could also employ a crossbar 104 with flat hooks 110 such as the previous embodiment; however, a single arm 106 with a single flat hook 110 could also be useful with the adjustment mechanism system 102.

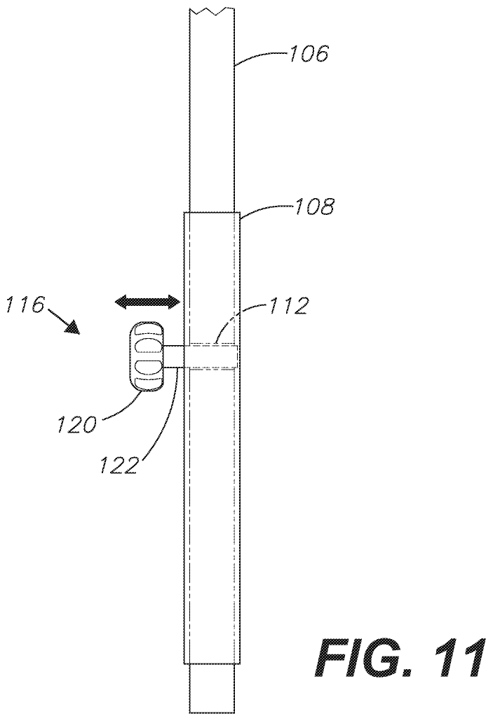

FIG. 11 shows how the grippable handle element 116, which includes the handle 120 and pin 122, can be drawn out and reinserted into a slot 112. A spring or some other element may be used to help retain the grippable handle 116 within the slide 108.

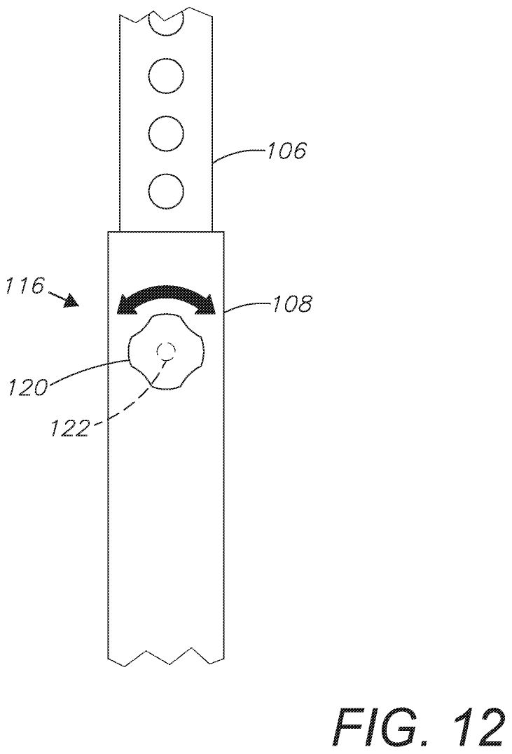

FIG. 12 shows the alternative where the pin 122 would have threads and could be twisted to be threaded or unthreaded into the slot 112.

### IV. Second Alternative Embodiment Adjustment Mechanism System 202

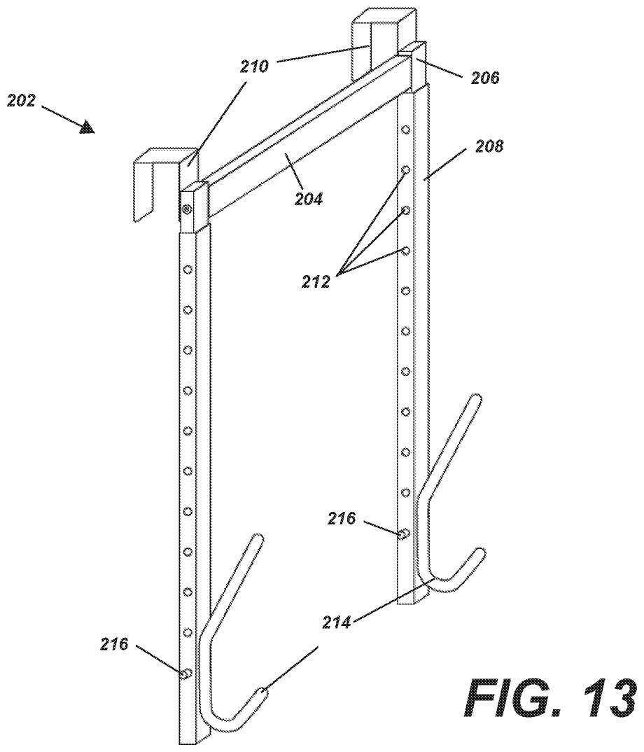

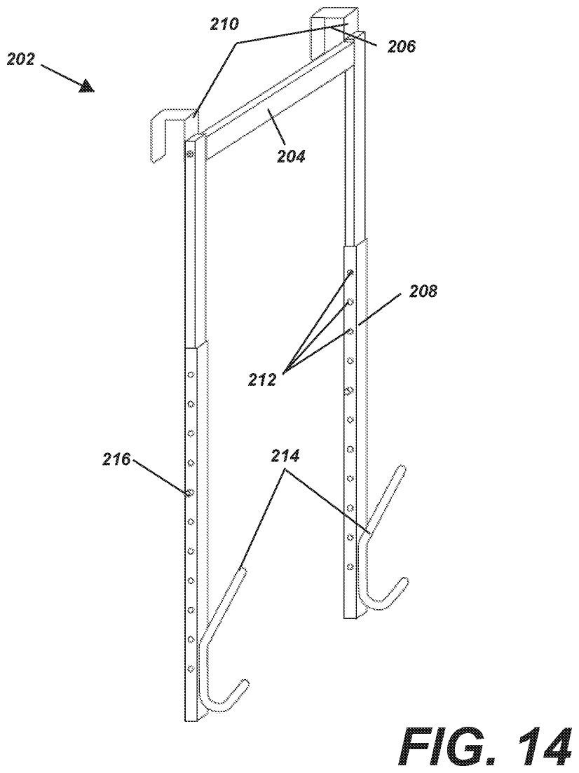

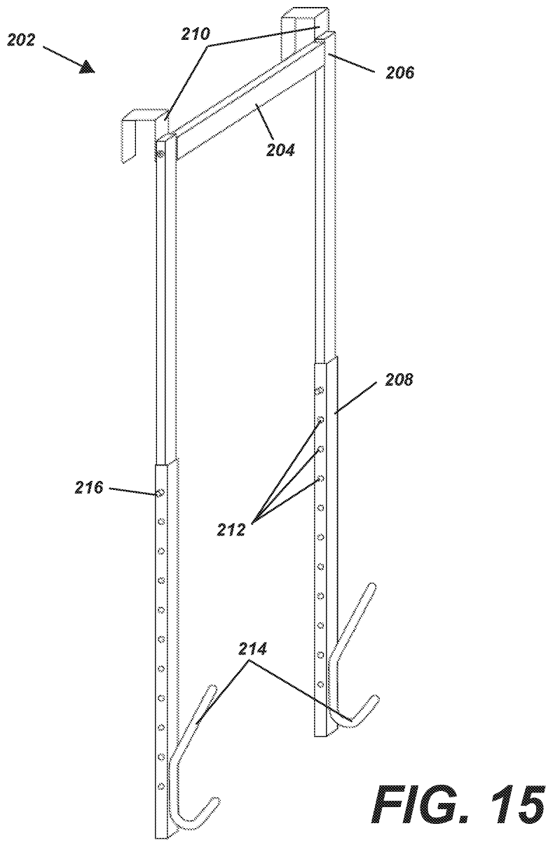

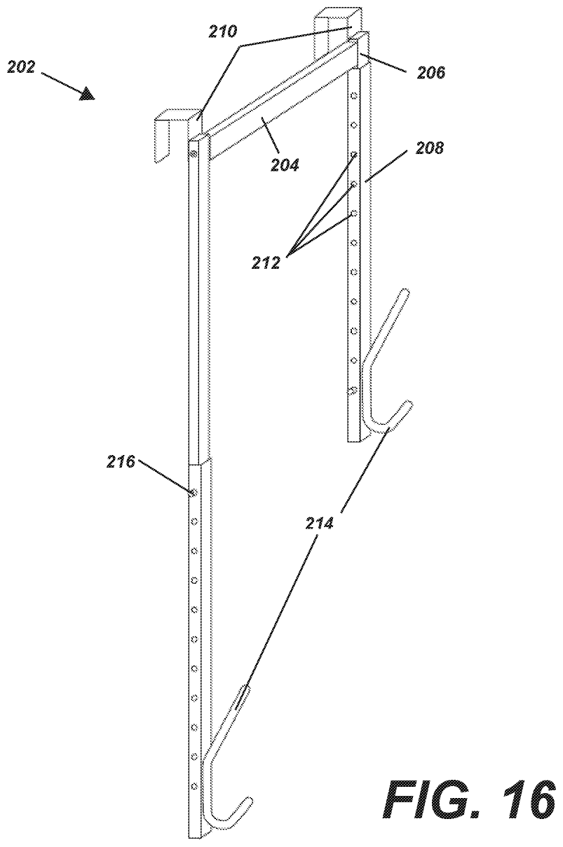

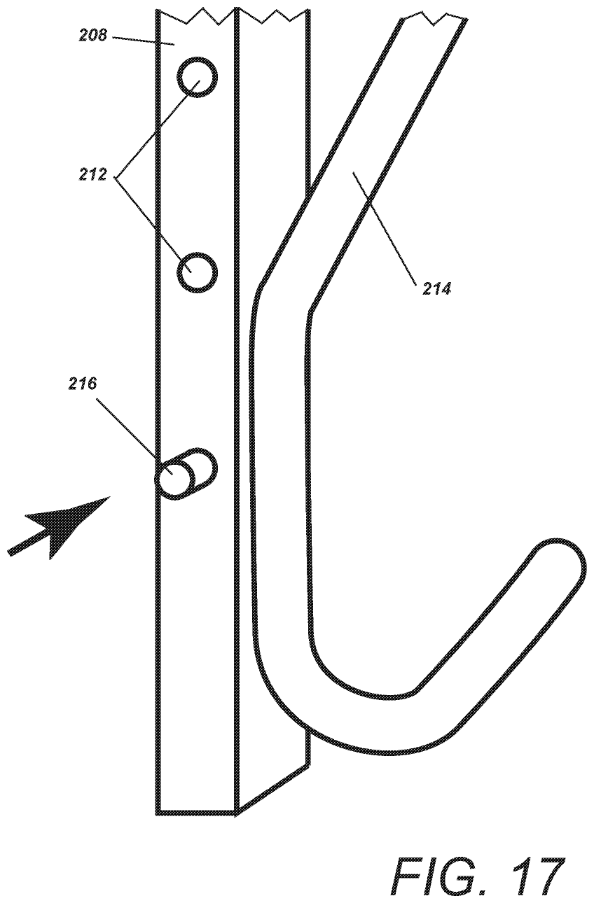

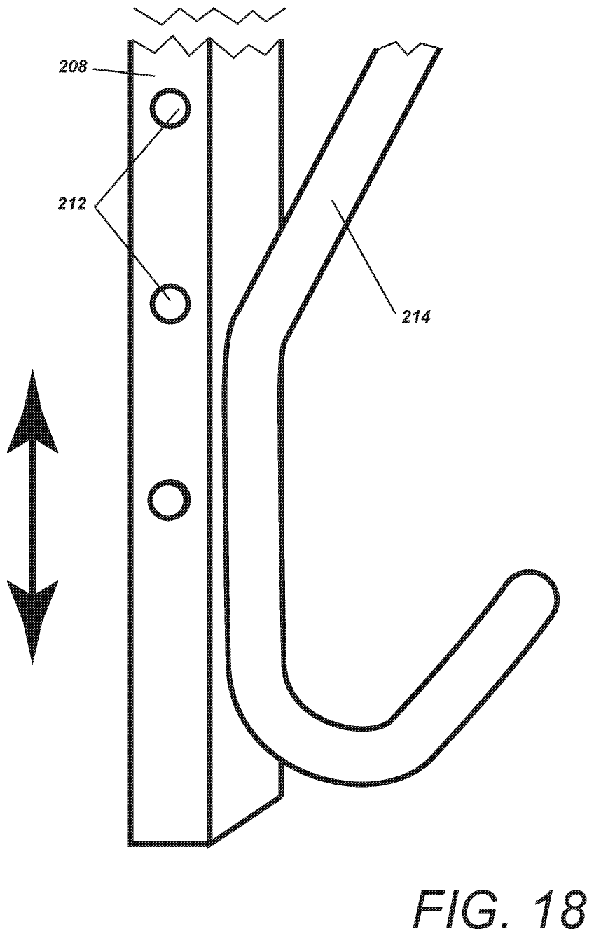

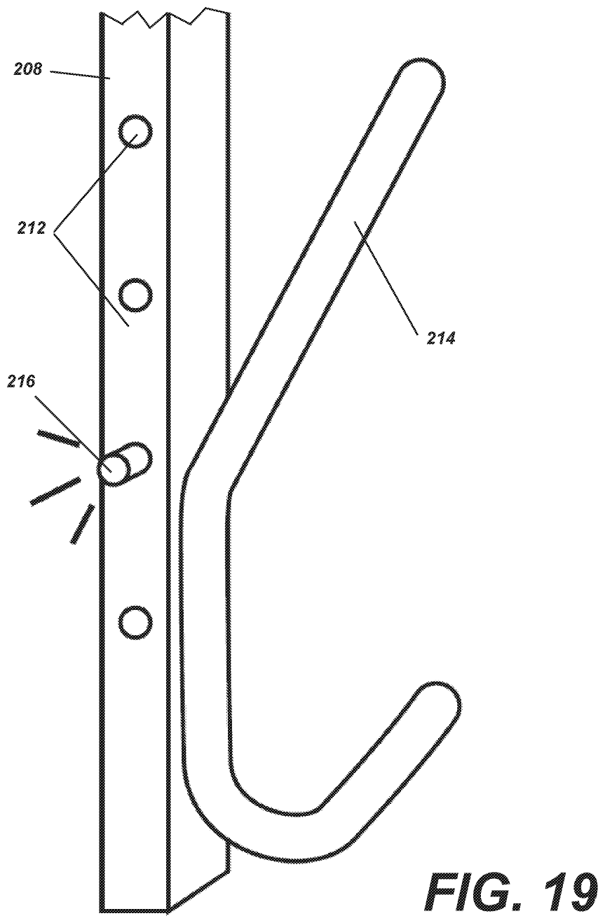

FIGS. 13-19 show another alternative embodiment adjustment mechanism system 202. As with the previous embodiments, the adjustment mechanism system 202 has a crossbar 204 with two over-the-door hooks 210 for hanging onto a door or other structure. A pair of arms 206 hang down from the crossbar 204. Slides 208 are connected to each separate arm 206 and can be slid up and down independent from one another. A number of notches 212 are located on the slides 208. A button 216 at the base of each arm 206 locks into one of the notches 212 as the slides 208 are slid downward to different levels. Hooks 214 or other elements can be connected to the slides 208 for receiving personal items. FIGS. 17-19 show more detail as to how the button 216 interacts with the notches 212 as the slides 208 are slid down and up the arms 206. FIG. 16 shows how each slide 208 can be independently slid up and down along the arms 206.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An adjustment management system for storage solutions, the system comprising:
a flat hook configured for hanging above a door;
a pair of vertically oriented arms;
a pair of slides, each slideably engaged with a respective one of said pair of vertically oriented arms;
an adjustment element configured for selectively engaging each said slide with its respective vertically oriented arm;
said slides further configured to provide storage solutions;
at least one hook extending from an exterior face of said slide; and
each of said pair of slides independently slideable from the other of said pair of slides such that each may be adjusted to a different height.

2. The adjustment management system of claim 1, wherein said adjustment element comprises a spring-powered button.

3. The adjustment management system of claim 2, wherein said spring-powered button is configured to engage with one of a plurality of slots located within a respective one of said pair of slides.

4. The adjustment management system of claim 1, further comprising an adjustment element comprising a grip and a pin configured for selectively engaging said slide with one of said plurality of slots.

5. The adjustment management system of claim 4, wherein said adjustment element comprises a spring element and is configured to be pulled out of a first one of said plurality of slots, and said spring element configured to automatically lock said adjustment element into a second one of said plurality of slots upon sliding said adjustment mechanism past said second one of said plurality of slots.

6. The adjustment management system of claim 4, further comprising:
said plurality of slots each comprising threadable receivers; and
said pin of said adjustment mechanism comprising threads for being received by said threadable receivers.

7. A storage management system comprising:
a flat hook configured for hanging above a door;
a pair of vertically oriented arms;
a pair of slides, each slideably engaged with a respective one of said pair of vertically oriented arms;
an adjustment element configured for selectively engaging each said slide with its respective vertically oriented arm, said adjustment element comprising a a spring-powered button;
said spring-powered button is configured to engage with one of a plurality of slots located within a respective one of said pair of slides;
said slides further configured to provide storage solutions;
at least one hook extending from an exterior face of said slide; and
each of said pair of slides independently slideable from the other of said pair of slides such that each may be adjusted to a different height

8. A method of adjusting a storage management system, the method comprising the steps:
engaging a pair of flat hooks of a horizontal crossbar with a top edge of a door, said horizontal crossbar comprising first end and a second end, and further comprising a first vertical arm extending from said first end and a second vertical arm extending from said second end;
slidably engaging a first slide with said first vertical arm and a second slide with said second vertical arm;
engaging said first slide with said first arm thereby temporarily locking said first slide into place along said first arm with a first adjustment element;
engaging said second slide with said second arm thereby temporarily locking said second slide into place along said second arm with a second adjustment element;
selectively disengaging said first adjustment element;
sliding said first slide along said first vertical arm; and
selectively reengaging said first adjustment element.

9. The method of claim 9, further comprising the steps:
said first adjustment element comprising a first spring-powered button configured to engage with one of a plurality of slots within said first slide; and
said second adjustment element comprising a second spring-powered button configured to engage with one of a plurality of slots within said second slide.

10. The method of claim 8, wherein said first adjustment element comprises a spring element and is configured to be pulled out of a first one of a plurality of slots within said first arm, and said spring element configured to automatically lock said adjustment element into a second one of said plurality of slots upon sliding said adjustment mechanism past said second one of said plurality of slots.

11. The method of claim 8, wherein:
said plurality of slots each comprising threadable receivers; and
said pin of said adjustment mechanism comprising threads for being received by said threadable receivers.
